(19) United States
(12) Patent Application Publication
(10) Pub. No.: US 2026/0350503 A1
(43) Pub. Date: Nov. 5, 2026

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Norihito OI, Tokyo (JP); Tooru IWAMOTO, Tokyo (JP); Tatsuya OSADA, Tokyo (JP)

(73) Assignee: NEC Corporation, Minato-ku, Tokyo (JP)

(21) Appl. No.: 19/105,093

(22) PCT Filed: Sep. 26, 2022
(86) PCT No.: PCT/JP2022/035602

§ 371 Date: Feb. 20, 2025

(51) Int. Cl. G06Q 10/0631; B60L 58/12; G06Q 50/40

(52) U.S. Cl. CPC G06Q 10/06315; B60L 58/12; G06Q 50/40

(57) ABSTRACT

The present invention provides a processing apparatus (10) including: a transportation task acquisition unit (11) that acquires transportation tasks carried out by a plurality of transportation vehicles each; a requisite power computation unit (12) that computes, for each of the transportation tasks, a requisite power being an amount of power required in a case where the transportation task is carried out by using a predetermined electric vehicle; and a number of vehicles computation unit (13) that computes, based on the requisite power for each of the transportation tasks, the number of the transportation vehicles replaceable with the predetermined electric vehicle.

### TECHNICAL FIELD

The present invention relates to a processing apparatus, a processing method, and a medium.

### BACKGROUND ART

Techniques relating to the present invention are disclosed in Patent Documents 1 to 4.

Patent Document 1 discloses a technique for determining, based on a discharge prediction amount in a case where travelling is performed in each of a plurality of delivery routes, a delivery route for each electric vehicle.

Patent Document 2 discloses a technique for selecting a delivery path and an electric car, based on a delivery location, a delivery time, load information of delivery, and battery remaining amounts of a plurality of electric cars.

Patent Document 3 discloses a technique for computing, based on electricity consumption for each processing section, a cruisable distance of an electric car.

Patent Document 4 discloses a technique for estimating electricity consumption of an electric vehicle, by considering a carrying amount of an electric vehicle, an operation state of an air conditioning apparatus, a drive tendency of a driver, a weather condition, a congestion situation of a traveling route, and the like.

### RELATED DOCUMENT

### Patent Document

Patent Document 1: International Patent Publication No. WO2020/241002
Patent Document 2: Japanese Patent Application Publication No. 2022-055976
Patent Document 3: Japanese Patent Application Publication No. 2014-212649
Patent Document 4: Japanese Patent Application Publication No. 2019-86430

### SUMMARY

### Technical Problem

In recent years, an electric vehicle is expected to prevail. Also, in a transportation vehicle which transports a person or an article, replacement of a diesel vehicle or a gasoline vehicle with an electric vehicle is expected.

As a side note, in a transportation operation, based on a previously-determined transportation plan, a predetermined transportation target is transported. In the transportation plan, for example, a transportation destination, transportation order, a time schedule, and the like are determined. In a case where an electric vehicle can perform transportation of a task similar to a transportation plan at a time at which a diesel vehicle or a gasoline vehicle is used, a diesel vehicle or a gasoline vehicle is easily replaced with an electric vehicle. However, a diesel vehicle or a gasoline vehicle is different from an electric vehicle in a characteristic (fuel consumption/electricity consumption, cruisable distances at times of fuel full tank/full charge, and the like). Therefore, a situation where it is difficult for an electric vehicle to perform transportation of a task which can be performed by a diesel vehicle or a gasoline vehicle may be caused.

For a transportation company which performs an operation using a transportation vehicle, it is not easy to decide whether a transportation operation of a task similar to a transportation plan at a time at which a diesel vehicle or a gasoline vehicle is used can be performed by an electric vehicle. Further, usually, the transportation company performs operations by using a plurality of transportation vehicles. A large amount of time and labor is required for performing the decision in each of the plurality of transportation vehicles. Therefore, a technique for assisting replacement of a transportation vehicle with an electric vehicle is expected.

The techniques disclosed in Patent Documents 1 and 2 are a technique for determining a delivery route of each electric vehicle, i.e., a technique used after introduction of an electric vehicle. In the techniques disclosed in Patent Documents 1 and 2, it is difficult to assist replacement of a transportation vehicle with an electric vehicle.

Patent Documents 3 and 4 disclose that a cruisable distance and electricity consumption of an electric vehicle are computed, but do not disclose a specific content which assists replacement of a transportation vehicle with an electric vehicle.

In view of the above-described problems, one example of an object of the present invention is to provide a processing apparatus, a processing method, and a medium that solve an issue of assisting replacement of a transportation vehicle with an electric vehicle.

### Solution to Problem

According to the present invention, provided is a processing apparatus including:
a transportation task acquisition unit that acquires transportation tasks carried out by a plurality of transportation vehicles each;
a requisite power computation unit that computes, for each of the transportation tasks, a requisite power being an amount of power required in a case where the transportation task is carried out by using a predetermined electric vehicle; and
a number of vehicles computation unit that computes, based on the requisite power for each of the transportation tasks, the number of the transportation vehicles replaceable with the predetermined electric vehicle.

Further, according to the present invention, provided is a processing method including,
by one or more computers;
   acquiring transportation tasks carried out by a plurality of transportation vehicles each;
   computing, for each of the transportation tasks, a requisite power being an amount of power required in a case where the transportation task is carried out by using a predetermined electric vehicle; and
   computing, based on the requisite power for each of the transportation tasks, the number of the transportation vehicles replaceable with the predetermined electric vehicle.

Further, according to the present invention, provided is a medium recording a program causing a computer to function as:
a transportation task acquisition unit that acquires transportation tasks carried out by a plurality of transportation vehicles each;
a requisite power computation unit that computes, for each of the transportation tasks, a requisite power being an amount of power required in a case where the transportation task is carried out by using a predetermined electric vehicle; and
a number of vehicles computation unit that computes, based on the requisite power for each of the transportation tasks, the number of the transportation vehicles replaceable with the predetermined electric vehicle.

### Advantageous Effects of Invention

According to one aspect of the present invention, a processing apparatus, a processing method, and a medium that solve an issue of assisting replacement of a transportation vehicle with an electric vehicle are achieved.

### BRIEF DESCRIPTION OF THE DRAWINGS

The above-described object, other objects, features, and advantages will become more apparent from public example embodiments described below and the following accompanying drawings.

FIG. 1 It is one example of a function block diagram of a processing apparatus.

FIG. 2 It is a diagram illustrating one example of a hardware configuration of the processing apparatus.

FIG. 3 It is a diagram schematically illustrating one example of information processed by the processing apparatus.

FIG. 4 It is a diagram schematically illustrating another example of information processed by the processing apparatus.

FIG. 5 It is a diagram illustrating one example of processing of computing requisite power.

FIG. 6 It is a diagram schematically illustrating another example of information processed by the processing apparatus.

FIG. 7 It is a diagram illustrating one example of a criterion for decision processing executed by the processing apparatus.

FIG. 8 It is a flowchart illustrating one example of a flow of processing of the processing apparatus.

FIG. 9 It is a diagram illustrating one example of a screen output by the processing apparatus.

FIG. 10 It is another example of a function block diagram of the processing apparatus.

### EXAMPLE EMBODIMENT

Hereinafter, example embodiments according to the present invention are described by using the accompanying drawings. Note that, in all drawings, a similar component is assigned with a similar reference sign, and description thereof is omitted as appropriate.

### First Example Embodiment

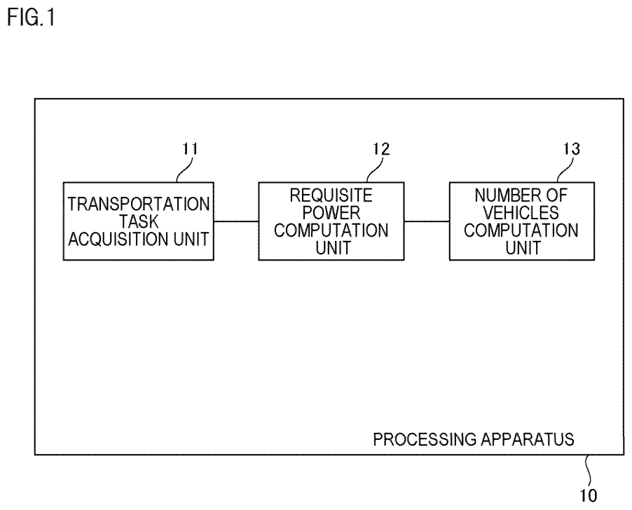

FIG. 1 is a function block diagram illustrating an outline of a processing apparatus 10 according to a first example embodiment. The processing apparatus 10 includes a transportation task acquisition unit 11, a requisite power computation unit 12, and a number of vehicles computation unit 13.

The transportation task acquisition unit 11 acquires transportation tasks carried out by a plurality of transportation vehicles each. The requisite power computation unit 12 computes, for each of the transportation tasks, a requisite power being an amount of power required in a case where the transportation task is carried out by using a predetermined electric vehicle. The number of vehicles computation unit 13 computes, based on the requisite power for each of the transportation tasks, the number of the transportation vehicles replaceable with the predetermined electric vehicle.

In this manner, the processing apparatus 10 decides, based on transportation tasks carried out by a transportation vehicle so far, how many units of possessed transportation vehicles are replaceable with an electric vehicle. According to such a processing apparatus 10, an issue of assisting replacement of a transportation vehicle with an electric vehicle is solved.

### Second Example Embodiment

### Outline

A processing apparatus 10 according to the present example embodiment is embodied by the processing apparatus 10 according to the first example embodiment. An outline of the processing apparatus 10 is as described below.

The processing apparatus 10 acquires transportation tasks carried out, in a past, by a plurality of transportation vehicles each being a candidate to be replaced with an electric vehicle. Next, the processing apparatus 10 computes, based on a predetermined simulation, an amount of power (a requisite power) required in a case where each of the transportation tasks is carried out by using a predetermined electric vehicle. Then, the processing apparatus 10 decides that a transportation vehicle involved in a transportation task in which the computed requisite power satisfies a predetermined condition (a transportation vehicle which has carried out the transportation task) is replaceable with a predetermined electric vehicle. The processing apparatus 10 integrates such decision results and computes the number of transportation vehicles replaceable with the predetermined electric vehicle. Hereinafter, details are described.

### “Hardware Configuration”

Next, one example of a hardware configuration of the processing apparatus 10 is described. Each function unit of the processing apparatus 10 is achieved based on any combination of hardware and software, mainly including a central processing unit (CPU) of any computer, a memory, a program loaded onto a memory, a storage unit (capable of storing, in addition to a program previously stored from a stage where an apparatus is shipped, a program downloaded from a storage medium such as a compact disc (CD), a server on the Internet, and the like) such as a hard disk storing the program, and a network-connection interface. Then, it can be understood by those of ordinary skill in the art that, in an achievement method and an apparatus for the above, there are various modified examples.

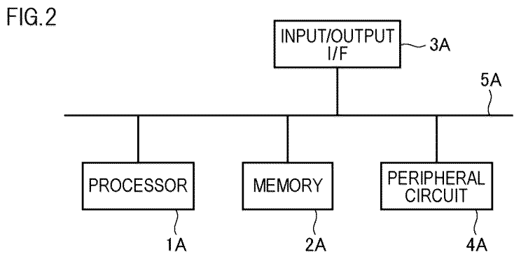

FIG. 2 is a block diagram illustrating a hardware configuration of the processing apparatus 10. As illustrated in FIG. 2, the processing apparatus 10 includes a processor 1A, a memory 2A, an input/output interface 3A, a peripheral circuit 4A, and a bus 5A. The peripheral circuit 4A includes various modules. The processing apparatus 10 may not necessarily include the peripheral circuit 4A. Note that, the processing apparatus 10 may be configured by a plurality of apparatuses physically and/or logically separated. In this case, each of the plurality of apparatuses can include the above-described hardware configuration.

The bus 5A is a data transmission path through which the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, or the like. The output apparatus is, for example, a display, a speaker, a printer, a mailer, or the like. The processor 1A can issue an instructions to each module, and perform an arithmetic operation, based on arithmetic operation results of the modules.

### “Function Configuration”

Next, a function configuration of the processing apparatus 10 is described. FIG. 1 illustrates one example of a function block diagram of the processing apparatus 10. As illustrated, the processing apparatus 10 includes a transportation task acquisition unit 11, a requisite power computation unit 12, and a number of vehicles computation unit 13.

The transportation task acquisition unit 11 acquires transportation tasks carried out by a plurality of transportation vehicles each.

The “transportation vehicle” is a vehicle being used for a transportation operation, and a vehicle to be a candidate for replacement with a predetermined electric vehicle. One example of the transportation vehicle is a diesel vehicle or a gasoline vehicle. In such a case, a user can receive assistance for replacement of a diesel vehicle or a gasoline vehicle with a predetermined electric vehicle. As another example, the transportation vehicle may be an electric vehicle. In such a case, a user can receive assistance for replacement of an electric vehicle which has been used so far with a predetermined new electric vehicle. A vehicle type of the transportation vehicle is not specifically limited, and includes every vehicle type such as an extra-large-size vehicle, a large-size vehicle, a medium-size vehicle, a standard-size vehicle, a light motor vehicle, and a two-wheel vehicle.

The “electric vehicle” is a vehicle traveling by using electric energy as a power source. Examples of the electric vehicle include, but not limited to, for example, an electric car, a plug-in hybrid vehicle, a hybrid vehicle, a fuel-cell vehicle, and the like. A vehicle type of the electric vehicle is not specifically limited, and includes every vehicle type such as an extra-large-size vehicle, a large-size vehicle, a medium-size vehicle, a standard-size vehicle, a light motor vehicle, and a two-wheel vehicle.

The “predetermined electric vehicle” is an electric vehicle scheduled to be introduced. In the predetermined electric vehicle, a type of an electric vehicle, a vehicle type, a manufacturer, and the like are determined.

The “transportation task” indicates a transportation destination, transportation order, and a weight of a transportation target object. The transportation target object is an article or a person. Examples of an operation in which the transportation target object is an article include, but not limited to, a home delivery operation, a route delivery operation in which product delivery is performed to a store such as a convenience store and a supermarket, a transportation operation in which an article is transported among a plurality of bases of a transportation company, and a move operation. Examples of an operation in which the transportation target object is a person include a traveling operation of a bus and the like. The transportation destination is a private residence, a company, a store, a bus stop, and the like. The transportation is a concept including delivery, collection, and the like of a transportation target object. A weight of a transportation target object indicated by the transportation task may be an individual weight of each transportation target object, or may be a total weight of a plurality of transportation target objects being transported.

The transportation task acquisition unit 11 may acquire a transportation plan indicating a transportation task. In addition, the transportation task acquisition unit 11 may acquire a transportation result indicating a transportation task.

The “transportation plan” is a plan for a transportation task to be carried out by each transportation vehicle. A worker circulates transportation destinations in order determined by the transportation plan, and transports a transportation target object.

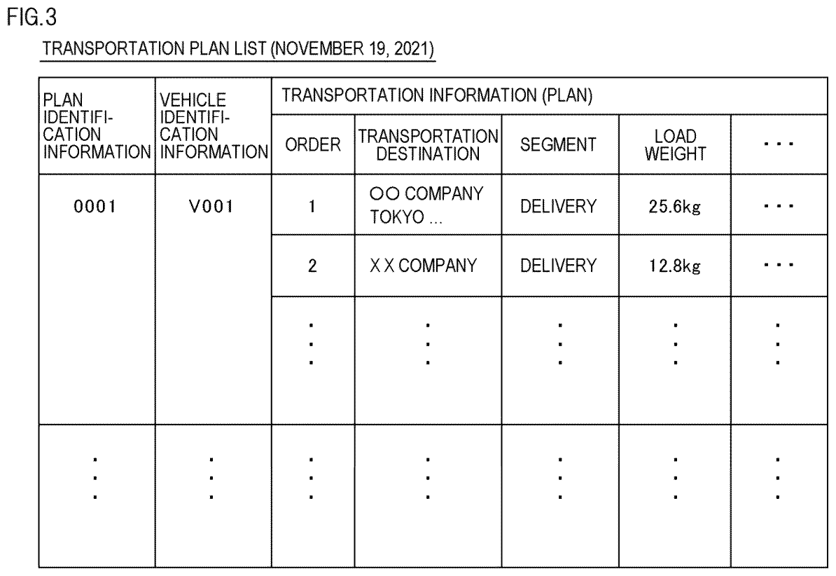

FIG. 3 illustrates one example of a transportation plan. The illustrated transportation plan is a plan in a home delivery operation in which articles are transported to a plurality of transportation destinations. Then, the illustrated transportation plan is a plan for a transportation operation on Nov. 19, 2021. In FIG. 3, plan identification information, vehicle identification information, and transportation information (a plan) are associated with one another. Note that, the transportation plan may include another piece of information such as weather information (a forecast or result) on a current day and the like.

The “plan identification information” is information identifying a plurality of transportation plans from one another.

The “vehicle identification information” is information identifying a plurality of transportation vehicles from one another. Each piece of plan identification information is associated with vehicle identification information of a transportation vehicle allocated to each transportation plan.

The “transportation information (a plan)” includes order, a transportation destination, a segment, and a load weight. Note that, the transportation information (a plan) may include another piece of information. For example, an arrival time for a transportation destination, a start time of transportation, and a finish time of transportation may be included.

The “order” indicates transportation order.

The “transportation destination” indicates a customer to which a load is delivered, and a name and an address of a customer from whom a load is collected.

The “segment” indicates a type of work, i.e., delivery or collection.

The “load weight” indicates a weight of a load to be delivered to a delivery destination or a weight of a load to be collected in a collection destination.

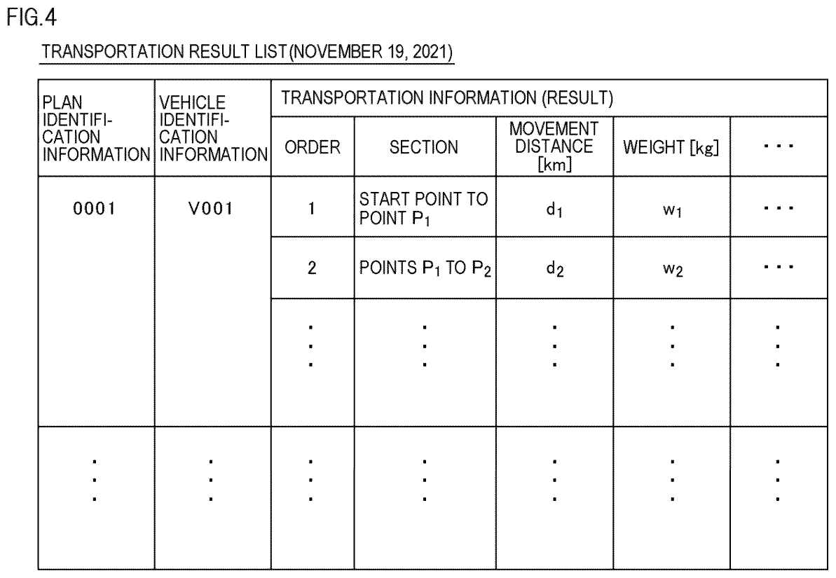

Next, the “transportation result” indicates a transportation task which has been actually carried out by each transportation vehicle. FIG. 4 illustrates one example of a transportation result. The illustrated transportation result is a result in a home delivery operation in which articles are transported to a plurality of transportation destinations. Then, the illustrated transportation result is a result in a transportation operation on Nov. 19, 2021. In FIG. 4, plan identification information, vehicle identification information, and transportation information (a result) are associated with one another. Note that, the transportation result may include another piece of information such as weather information (a forecast or a result) on a current day and the like.

The “plan identification information” and the “vehicle identification information” are described above. The “transportation information (a result)” includes order, a section, a movement distance, and a weight. Note that, the transportation information (a result) may include another piece of information.

The “order” indicates traveling order.

The “section” indicates a section where traveling is performed. For example, to a first transportation destination from a start point becomes a first section, and to a next transportation destination from the first transportation destination becomes a next section.

The “movement distance” indicates a distance where movement is performed in each section.

The “weight” indicates a total weight (carrying amount) of transportation target objects that are transported by a transportation vehicle in a case where movement is performed in each section.

Such a transportation result may be generated based on a sensor (a weight sensor, a global positioning system (GPS), a camera, or the like) mounted on a vehicle. The movement distance may be achieved, for example, by detecting a movement track by a GPS and computing a distance of the movement track. Further, the weight may be achieved based on measurement using a weight sensor mounted on a vehicle. In addition, in a case where a transportation vehicle is a bus, the number of passengers is detected by a camera, and thereby a value acquired by multiplying the number of passengers by a body weight of a common person may be computed as a weight. In this case, an attribute (an adult male, an adult female, a child, an elderly person, or the like) of a boarding person is further determined by an image analysis, a value acquired by multiplying the number of persons of each attribute by a common weight of the each attribute is computed, and thereby a sum of computed values may be computed as the weight.

A means for acquiring, by the transportation task acquisition unit 11, a transportation plan or a transportation result indicating a transportation task as described above is not specifically limited. For example, a user may input, to the processing apparatus 10, data of a transportation plan or a transportation result indicating a transportation task as described above. In addition, past data of a transportation plan or a transportation result indicating a transportation task as described above may be previously stored in a predetermined storage apparatus. The storage apparatus may be provided inside the processing apparatus 10, or may be provided inside an external apparatus configured communicably with the processing apparatus 10. Then, the transportation task acquisition unit 11 may acquire, from the storage apparatus, data of a transportation plan or a transportation result indicating a transportation task as described above.

The transportation task acquisition unit 11 may acquire one transportation task in association with one transportation vehicle, or may acquire a plurality of transportation tasks. The one transportation task indicates a transportation task on a certain day. The plurality of transportation tasks indicate transportation tasks on a plurality of days each. In the latter case, the transportation task acquisition unit may acquire, for example, a transportation task in a predetermined period (e.g., a most recent one month, most recent six months, or the like). As described above, in a case where a transportation task is acquired from the storage apparatus as described above, for example a user may specify whether acquiring one transportation task in association with one transportation vehicle or acquiring a plurality of transportation tasks. Then, in a case where it is specified that a plurality of transportation tasks are acquired, a user may further specify a predetermined period (e.g., Jan. 1, 2021 to Dec. 31, 2021). Then, the transportation task acquisition unit 11 may acquire, from the storage apparatus, a transportation task in the specified predetermined period.

Referring back to FIG. 1, the requisite power computation unit 12 computes, for each transportation task, a requisite power being an amount of power (kWh) required in a case where a transportation task acquired by the transportation task acquisition unit 11 is carried out by using a predetermined electric vehicle.

In a case where the transportation task acquisition unit 11 acquires one transportation task in association with one transportation vehicle, the requisite power computation unit 12 computes a requisite power required for carrying out the transportation task. In a case where the transportation task acquisition unit 11 acquires a plurality of transportation tasks in association with one transportation vehicle, the requisite power computation unit 12 computes, for each of the transportation tasks, a requisite power required for carrying out each of the transportation tasks.

There are various methods for computing requisite power, and hereinafter, one example is described.

The requisite power computation unit 12, for example, determines, based on a transportation task, a traveling route, and computes a velocity, a velocity gradient, and the like of an electric vehicle during traveling in the traveling route. The velocity can be determined based on a legal velocity in each position. Further, the velocity gradient can be determined according to a road situation (a straight line, a curve, a sharp curve, or the like). A legal velocity and a road situation in each position are indicated by map data. Next, the requisite power computation unit 12 computes, based on the computation result, energy required for carrying out the transportation task. A means for computing, from a velocity or a velocity gradient of a vehicle, energy required for traveling is widely known, and therefore, description thereof is omitted herein. Then, the requisite power computation unit 12 converts the computed energy into an amount of power (requisite power).

As another example, the requisite power computation unit 12 computes, based on a transportation task acquired by the transportation task acquisition unit 11, electricity consumption (km/kWh) in a case where the transportation task is carried out by using a predetermined electric vehicle, divides, by the electricity consumption, a movement distance indicated by the transportation task, and thereby may compute requisite power.

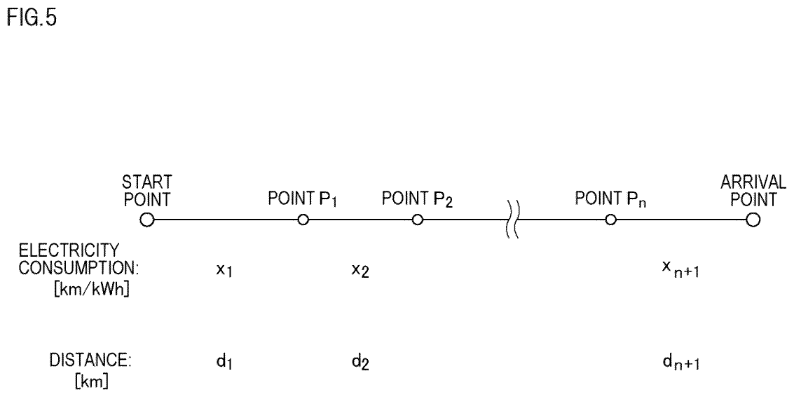

As a side note, electricity consumption may vary according to a carrying amount and a road situation. Therefore, the requisite power computation unit 12 may divide, as illustrated in FIG. 5, a transportation route into a plurality of sections, and compute, for each section, electricity consumption and a distance. Then, the requisite power computation unit 12 may compute a requisite power for sections each by dividing, for the sections each, a movement distance by electricity consumption, add the resulting requisite powers, and thereby compute the requisite power.

There are various ways for division into a plurality of sections, and cited is an example in which, for example, a section from a start point to a first transportation destination is set as one section, a section from a certain transportation destination to a next transportation destination is set as one section, and a section from a last transportation destination to an arrival point is set as one section.

Electricity consumption in each section is determined by considering a carrying amount in each section, information (a pavement situation of a road, a predicted congestion situation of a road, a gradient situation of a road, a curvature radius of a curve present in a path, the number of right/left turns present in a path, and the like) relating to the path to be passed in each section, a weather situation (weather, temperature, humidity, wind velocity, and the like) on a current day, a vehicle type, air resistance according to a vehicle type, a manufacturer, power consumption due to mounting, and the like. The information relating to a path to be passed in each section is determined based on map data. In the map data, a pavement situation in each position, a general congestion situation, a gradient situation, a curvature radius of a curve, and the like are indicated.

For each condition generated by connecting these items based on a logical operator, a reference table in which electricity consumption at a time at which the condition is satisfied is registered is previously generated, and thereby, the generated reference table may be registered in the processing apparatus 10. Then, the requisite power computation unit 12 may determine, based on a condition satisfied by each section, electricity consumption in the each section. The condition includes, for example, a “carrying amount: W₁ (kg) or more, and, weather: clear, and, temperature: equal to or more than 15 °C and equal to or less than 25 °C, and, . . . ” and the like.

In addition, an arithmetic expression for computing electricity consumption by inputting a value of the item is previously generated, and the generated arithmetic expression may be registered in the processing apparatus 10. Then, the requisite power computation unit 12 may input, for each section, a value of the item to the arithmetic expression, and thereby, determine electricity consumption in each section.

In addition, by using machine learning based on training data in which a combination of values of a plurality of types of items described above and electricity consumption at a time at which the plurality of types of items take the values each are associated with each other, a learning model in which electricity consumption is estimated from the combination of the values of the plurality of types of items may be generated. Then, the requisite power computation unit 12 may input, for each section, a value of the item to the learning model, and thereby, determine electricity consumption in each section.

A distance in each section may be computed, for example, based on map data. For example, a route in a case where transportation is performed according to a transportation plan may be computed by any means, and thereby, a distance in a case where traveling is performed in the route may be computed based on the map data. Further, in a case where a distance (a result of a movement distance of a transportation vehicle) in each section is indicated based on the above-described transportation result, the information may be used.

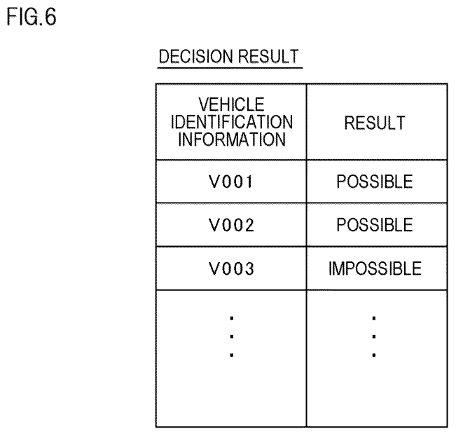

Referring back to FIG. 1, the number of vehicles computation unit 13 computes, based on a requisite power for each transportation task, the number of transportation vehicles replaceable with a predetermined electric vehicle. Specifically, the number of vehicles computation unit 13 decides, for each transportation vehicle, based on a requisite power in a transportation task carried out by each of the transportation vehicles, whether replacement with a predetermined electric vehicle is possible. Then, the number of vehicles computation unit 13 computes, based on a decision result (see FIG. 6) for each of the transportation vehicles, the number of the transportation vehicles replaceable with the predetermined electric vehicle.

Hereinafter, processing of the number of vehicles computation unit 13 is specifically described separately in a “case where the transportation task acquisition unit 11 acquires one transportation task in association with one transportation vehicle” and in a “case where the transportation task acquisition unit 11 acquires a plurality of transportation tasks in association with one transportation vehicle”.

### Case (1) Where the Transportation Task Acquisition Unit 11 Acquires One Transportation Task in Association with One Transportation Vehicle

In this case, the number of vehicles computation unit 13 decides that a transportation vehicle involved in a transportation task in which a requisite power is equal to or less than a first threshold value is replaceable with an electric vehicle. Then, the number of vehicles computation unit 13 decides that a transportation vehicle involved in a transportation task in which a requisite power is larger than the first threshold value is not replaceable with an electric vehicle.

The “first threshold value” is determined based on a battery characteristic of a predetermined electric vehicle (an electric vehicle scheduled to be introduced). The battery characteristic is a battery capacity (kWh), a state of health (SOH), and the like. In a case where introduction of a used electric vehicle is under consideration, the SOH is usable.

For example, a charge amount of power at a time of full charge may be set as the first threshold value. In addition, a value acquired by subtracting a predetermined value from a full charge amount of power at a time of full charge, or a value acquired by multiplying a full charge amount of power at a time of full charge by a correction coefficient with a value less than one may be set as the first threshold value.

A user may determine the first threshold value, and input the determined first threshold value to the processing apparatus 10. In addition, a user may input, to the processing apparatus 10, the battery characteristic of a predetermined electric vehicle. Then, the number of vehicles computation unit 13 may compute the first threshold value, based on the input battery characteristic.

### Case (2) Where the Transportation Task Acquisition Unit 11 Acquires One Transportation Task in Association with One Transportation Vehicle

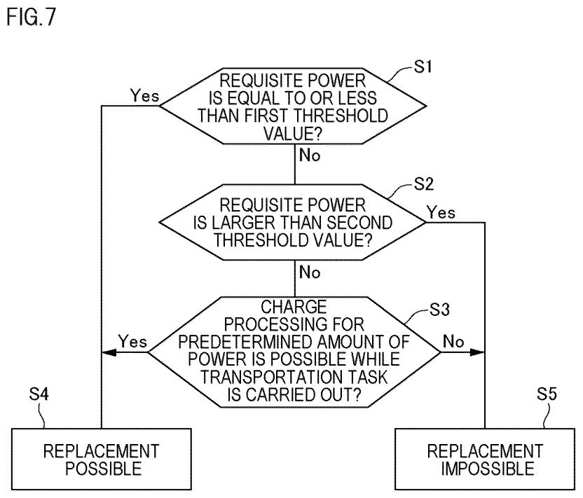

In this case, the number of vehicles computation unit 13 performs the decision by considering that charge processing is executed during transportation. Specifically, the number of vehicles computation unit 13 performs decision, based on a criterion as illustrated in FIG. 7.

First, the number of vehicles computation unit 13 decides that a transportation vehicle involved in a transportation task in which a requisite power is equal to or less than the first threshold value (Yes in S1) is replaceable with an electric vehicle (S4).

Further, the number of vehicles computation unit 13 decides that a transportation vehicle involved in a transportation task in which a requisite power is larger than the first threshold value (No in S1) and equal to or less than a second threshold value (No in S2), and charge processing for a predetermined amount of power is possible while the transportation task is carried out (Yes in S3) is replaceable with an electric vehicle (S4).

Then, the number of vehicles computation unit 13 decides that a transportation vehicle involved in a transportation task in which a requisite power is larger than the first threshold value (No in S1) and equal to or less than the second threshold value (No in S2), but charge processing for a predetermined amount of power is impossible while the transportation task is carried out (No in S3) is not replaceable with an electric vehicle (S5).

Further, the number of vehicles computation unit 13 decides that a transportation vehicle involved in a transportation task in which a requisite power is lager that the second threshold value (Yes in S2) is not replaceable with an electric vehicle (S5).

The “first threshold value” can be determined by a means similar to the “case (1) where the transportation task acquisition unit 11 acquires one transportation task in association with one transportation vehicle” described above.

The “predetermined amount of power” used for decision in S3 can be computed based on a difference between a requisite power and the first threshold value. The difference is an amount of power insufficient in a case where a transportation task is carried out in a state where an electric vehicle is fully charged before transportation start. For example, the difference may be set as the predetermined amount of power, or a value acquired by adding a predetermined value to the difference or a value acquired by multiplying the difference by a correction coefficient larger than one may be set as the predetermined amount of power.

A user may determine the predetermined amount of power, and thereby, input the determined predetermined amount of power to the processing apparatus 10. In addition, the number of vehicles computation unit 13 may compute the predetermined amount of power, based on a previously-determined computation method.

The “second threshold value” is any value larger than the first threshold value. In a case where a requisite power exceeds the second threshold value, an amount of power insufficient in a case where a transportation task is carried out in a state where an electric vehicle is fully charged before transportation start is large to an extent that it is difficult to provide the amount of power by charge processing during transportation. Therefore, in a case where a requisite power exceeds the second threshold value, decision as being not replaceable is performed without performing decision in S3.

Herein, the decision in S3, i.e., one example of decision of “whether it is possible to execute charge processing for a predetermined amount of power while a transportation task is carried out” is described. The number of vehicles computation unit 13, for example, can decide, in a case where a predetermined charge condition is satisfied, that charge processing for a predetermined amount of power is possible while a transportation task is carried out, and decide, in a case where a predetermined charge condition is not satisfied, that the charge processing is impossible.

The predetermined charge condition can be assumed as a matter acquired by connecting, based on an and condition or an or condition, one or both of
a matter that a transportation task is in a state where a predetermined charge time can be ensured, and
a matter that there is a charge facility on a transportation route or within a predetermined distance from the transportation route.

The “predetermined charge time” is a time required for charge processing for a predetermined amount of power. The predetermined charge time can be computed based on a predetermined amount of power and a charge speed (e.g., a standard value) of a predetermined electric vehicle.

For example, in a transportation task acquired by the transportation task acquisition unit 11, a time at which all transportations are finished and a return is made to an arrival point may be indicated. Then, the number of vehicles computation unit 13 may decides, in a case where a difference between the time at which a return is made to an arrival point and a predetermined end of work time is larger than a predetermined charge time, “a matter that a transportation task is in a state where a predetermined charge time can be ensured”.

In addition, in a transportation task acquired by the transportation task acquisition unit 11, a break time (including a lunch time) may be indicated. Then, the number of vehicles computation unit 13 may decide, in a case where the break time is larger than a predetermined charge time, “a matter that a transportation task is in a state where a predetermined charge time can be ensured”.

In addition, in a transportation task acquired by the transportation task acquisition unit 11, a break time (including a lunch time) and break timing may be determined. Then, the number of vehicles computation unit 13 may decide, in a case where the break time is larger than a predetermined charge time and a charge facility is present within a predetermined distance from a position of a transportation vehicle at a time of taking a break, “a matter that a transportation task is in a state where a predetermined charge time can be ensured”.

Then, the number of vehicles computation unit 13 may decides, in a case where a condition as described above is not satisfied, “a matter that a transportation task is not in a state where a predetermined charge time can be ensured”.

Decision of “whether a charge facility is present on a transportation route or within a predetermined distance from the transportation route” and decision of “whether a charge facility is present within a predetermined distance from a position of a transportation vehicle at a time of taking a break” can be achieved based on map data. In the map data, an installation position of a charge facility is indicated. A position of a transportation vehicle at a time of taking a break is computed based on a transportation plan. In the transportation plan, for example, a prediction position of a transportation vehicle at a time of taking a break may be indicated in a predetermined range.

### Case (1) Where the Transportation Task Acquisition Unit 11 Acquires a Plurality of Transportation Tasks in Association with One Transportation Vehicle

In this case, the number of vehicles computation unit 13 decides, based on a requisite power in each of a plurality of transportation tasks carried out by each transportation vehicle, whether each of the transportation vehicles is replaceable with a predetermined electric vehicle.

Specifically, the number of vehicles computation unit 13 decides, in a case where a predetermined number or more or a predetermined ratio or more of a plurality of transportation tasks carried out by each transportation vehicle satisfies a predetermined condition based on a requisite power, that each of the transportation vehicles is replaceable with a predetermined electric vehicle. Then, the number of vehicles computation unit 13 can decide, in a case other than the above, that each transportation vehicle is not replaceable with the predetermined electric vehicle.

The predetermined condition is at least one of the “conditions for deciding that a transportation vehicle is replaceable with an electric vehicle” described in the “case (1) where the transportation task acquisition unit 11 acquires one transportation task in association with one transportation vehicle” and the “case (2) where the transportation task acquisition unit 11 acquires one transportation task in association with one transportation vehicle”.

Specifically, the predetermined condition includes at least one of
a matter that a requisite power is equal to or less than the first threshold value, and
a matter that a requisite power is larger than the first threshold value and equal to or less than the second threshold value, and charge processing for a predetermined amount of power is possible while a transportation task is carried out.

### Case (2) Where the Transportation Task Acquisition Unit 11 Acquires a Plurality of Transportation Tasks in Association with One Transportation Vehicle

In this case, the number of vehicles computation unit 13 decides, based on a variation degree of a requisite power in each of a plurality of transportation tasks carried out by each transportation vehicle, that each of the transportation vehicles is replaceable with a predetermined electric vehicle.

An indicator indicating a variation degree is not specifically limited, and for example, a fraction, a standard deviation, and the like are usable.

The number of vehicles computation unit 13 can decide, in a case where a predetermined number or more or a predetermined ratio or more of a plurality of transportation tasks carried out by each transportation vehicle satisfies the predetermined condition based on a requisite power, and the variation degree (a fraction, a standard deviation, or the like) is equal to or less than a threshold value, that each of the transportation vehicles is replaceable with a predetermined electric vehicle. Then, the number of vehicles computation unit 13 can decide, in a case other than the above, that each transportation vehicle is not replaceable with the predetermined electric vehicle.

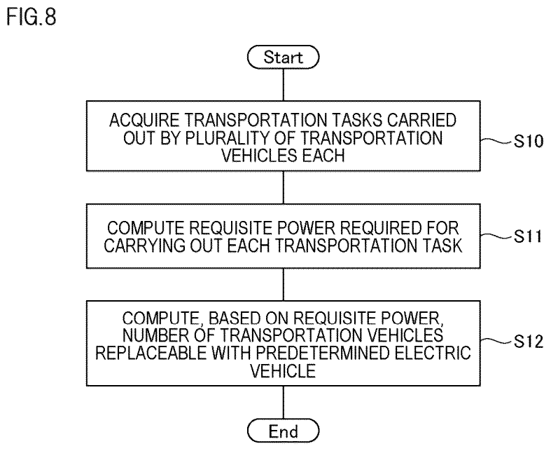

Next, by using a flowchart in FIG. 8, one example of a flow of processing of the processing apparatus 10 is described.

First, the processing apparatus 10 acquires transportation tasks carried out by a plurality of transportation vehicles each (S10). The step is executed by the transportation task acquisition unit 11 described above.

Next, the processing apparatus 10 computes, for each of the transportation tasks, a requisite power being an amount of power required in a case where the transportation task is carried out by using a predetermined electric vehicle (S11). The step is executed by the requisite power computation unit 12 described above.

Then, the processing apparatus 10 computes, based on the requisite power for each of the transportation tasks, the number of the transportation vehicles replaceable with the predetermined electric vehicle (S12). The step is executed by the number of vehicles computation unit 13 described above.

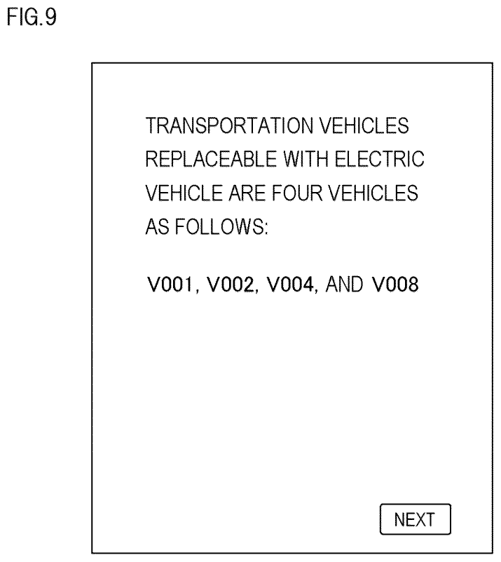

After S12, the processing apparatus 10 can output a computation result. The processing apparatus 10 may output, for example, a screen as illustrated in FIG. 9. In the screen illustrated in FIG. 9, information identifying replaceable transportation vehicles is indicated, and the number of the replaceable transportation vehicles are also indicated. Output on such a screen is achieved by using an output apparatus such as a display, a printer, and a mailer.

### “Advantageous Effect”

The processing apparatus 10 according to the present example embodiment decides, based on transportation tasks carried out by a plurality of transportation vehicles each, whether each transportation vehicle is replaceable with a predetermined electric vehicle, and thereby, can compute, based on the decision result, the number of transportation vehicles replaceable with the predetermined electric vehicle. In this manner, based on transportation tasks carried out by a plurality of transportation vehicles each, various types of decision and computation are performed, and thereby the number of transportation vehicles replaceable with a predetermined electric vehicle can be accurately computed.

Further, the processing apparatus 10 according to the present example embodiment can decide, based on a plurality of transportation tasks carried out by each transportation vehicle, whether each of the transportation vehicles is replaceable with a predetermined electric vehicle. A transportation route and a transportation target of each of the transportation vehicles may be different with respect to each relevant day. The decision is performed based on a plurality of transportation tasks, and thereby inconvenience in which a wrong decision is performed can be reduced.

Further, the processing apparatus 10 according to the present example embodiment can decide, based on one transportation task carried out by each transportation vehicle, whether each of the transportation vehicles is replaceable with a predetermined electric vehicle. For example, in a case of route delivery or the like, transportation routes or transportation targets of each of the transportation vehicles may be the same or substantially the same every day. In this case, even in a case where the decision is performed based on one transportation task, a wrong decision does not result. Then, the number of transportation tasks to be processed can be reduced, and therefore a processing load on a computer can be reduced.

Further, the processing apparatus 10 can decide, by considering that charge processing is executed while transportation is performed, whether each transportation vehicle is replaceable with an electric vehicle. As a result, a decision result more matched with an actual situation can be acquired.

### Third Example Embodiment

A processing apparatus 10 according to the present example embodiment includes a function for computing an effect and the like in a case where replacement of a computed number of vehicles (replacement of a transportation vehicle so far with an electric vehicle) is performed. Hereinafter, details are described.

A number of vehicles computation unit 13 further computes at least one of a cost in a case where replacement of a computed number of vehicles is performed, and a CO₂ reduction effect.

### Computation of Cost

For example, a rough standard for a cost in a case where replacement of one vehicle is performed may be previously registered in the processing apparatus 10. Then, the number of vehicles computation unit 13 may compute, as a cost, a product acquired by multiplying a cost for the one vehicle by a computed number of vehicles.

In addition, the number of vehicles computation unit 13 may compute the cost, by considering a difference in a cost required for replacement for each transportation vehicle. In this case, previously, based on an attribute of a transportation vehicle, transportation vehicles are grouped, and a cost of replacement of one vehicle may be registered for each group. Then, the number of vehicles computation unit 13 acquires, based on any means, an attribute of each transportation vehicle decided as being replaceable, and thereby, determines, based on the acquired attribute, a group to which each of the transportation vehicles belongs. Then, the number of vehicles computation unit 13 determines a cost associated with the determined group as a cost required for replacement of the transportation vehicle, and also computes a sum of costs for each of the determined transportation vehicles as a cost required for replacement of vehicles determined as being replaceable. Examples of the attribute of a transportation vehicle include, but not limited to, a type (a diesel vehicle/a gasoline vehicle/an electric car/a plug-in hybrid car/a hybrid car/a fuel-cell vehicle/and the like), a vehicle type (an extra-large-size vehicle/a large-size vehicle/a medium-size vehicle, a standard-size vehicle, a light motor vehicle, a two-wheel vehicle, and the like), a manufacturer, a traveling distance, a model year, a type number, an accident history, and the like.

### Computation of CO₂ Reduction Effect

For example, a rough standard for a CO₂ reduction amount in a case where replacement of one vehicle is performed may be previously registered in the processing apparatus 10. Then, the number of vehicles computation unit 13 may compute, as a CO₂ reduction amount (CO₂ reduction effect), a product of the CO₂ reduction amount for the one vehicle and a computed number of vehicles.

In addition, the number of vehicles computation unit 13 may compute the CO₂ reduction amount, by considering a difference in a CO₂ emission amount for each transportation vehicle. In this case, previously, based on an attribute of a transportation vehicle, transportation vehicles are grouped, and a CO₂ reduction amount for one vehicle in a case where replacement with a predetermined electric vehicle is performed may be registered for each group. Then, the number of vehicles computation unit 13 acquires, based on any means, an attribute of each transportation vehicle decided as being replaceable, and thereby, determines, based on the acquired attribute, a group to which each of the transportation vehicles belongs. Then, the number of vehicles computation unit 13 determines a CO₂ reduction amount associated with the determined group as a CO₂ reduction amount achieved based on replacement of the transportation vehicle, and also computes a sum of CO₂ reduction amounts of each of the determined transportation vehicles as a CO₂ reduction amount achieved by replacement of vehicles determined as being replaceable. Examples of the attribute of a transportation vehicle include, but not limited to, a type (a diesel vehicle/a gasoline vehicle/an electric car/a plug-in hybrid car/a hybrid car/a fuel-cell vehicle/and the like), a vehicle type (an extra-large-size vehicle/a large-size vehicle/a medium-size vehicle, a standard-size vehicle, a light motor vehicle, a two-wheel vehicle, and the like), a manufacturer, a traveling distance, a model year, a type number, an accident history, and the like.

The processing apparatus 10 further outputs at least one of a cost in a case where replacement of a computed number of vehicles is performed, and a CO₂ reduction effect, in addition to information identifying a transportation vehicle replaceable with a predetermined electric vehicle and the number of relevant vehicles. The processing apparatus 10 can achieve the output by using an output apparatus such as a display, a printer, and a mailer.

Other configurations of the processing apparatus 10 are similar to those of the first and second example embodiments.

According to the processing apparatus 10 of the present example embodiment, an advantageous effect similar to that of the first and second example embodiments is achieved. Further, according to the processing apparatus 10 of the present example embodiment, at least one of a cost in a case where replacement of a computed number of vehicles is performed, and a CO₂ reduction effect can be output to a user. In this manner, the processing apparatus 10 can output, to a user, information to be a decision material for replacement.

### Fourth Example Embodiment

A processing apparatus 10 according to the present example embodiment includes a function of assisting, after an electric vehicle is introduced, an operation using the electric vehicle. Specifically, the processing apparatus 10 according to the present example embodiment includes a function of monitoring a change in a state of an introduced electric vehicle, and generating and outputting, based on a state at a current time and transportation tasks carried out by the electric vehicle so far, advice information relating a future usage method for the electric vehicle. Hereinafter, details are described.

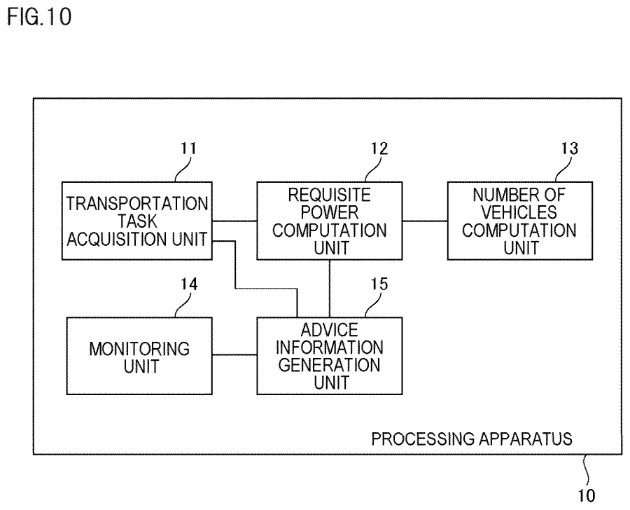

FIG. 10 illustrates one example of a function block diagram of the processing apparatus 10. As illustrated, the processing apparatus 10 includes a transportation task acquisition unit 11, a requisite power computation unit 12, a number of vehicles computation unit 13, a monitoring unit 14, and an advice information generation unit 15.

The monitoring unit 14 monitors a change in a state of an electric vehicle replaced from a transportation vehicle.

The monitoring unit 14 may monitor, for example, a temporal change in an SOH from a time of introduction of an electric vehicle. In this case, the monitoring unit 14 acquires, for each predetermined period, an SOH of the electric vehicle in the period. Measurement of the SOH is achieved by using any well-known technique.

In addition, the monitoring unit 14 may monitor a temporal change in electricity consumption from a time of introduction of an electric vehicle. In this case, the monitoring unit 14 acquires, for each predetermined period, electricity consumption of the electric vehicle in the period. The electricity consumption acquired by the monitoring unit 14 is a value computed, for example, based on a distance where traveling is actually performed and a power consumption amount in the period. Note that, measurement of electricity consumption for each predetermined period is preferably performed by gathering, to a possible extent, factors which may affect electricity consumption such as a carrying amount and a traveling route. For example, in a case of route delivery or the like, daily transportation routes or transportation targets may be the same or substantially the same. In an electric vehicle used for such route delivery, electricity consumption may be monitored.

The advice information generation unit 15 generates and outputs, based on a state of an electric vehicle at a current time and transportation tasks carried out by the electric vehicle so far, advice information relating to a future usage method for the electric vehicle.

First, the advice information generation unit 15 computes a variation degree among transportation tasks carried out by the electric vehicle so far. The variation degree, for example, may be a variation degree among traveling distances, may be a variation degree among carrying amounts (a maximum value, a median, or the like during transportation), or may be another variation degree.

Then, the advice information generation unit 15 can generate and output advice information by using a criterion according to each of a case where the variation degree is equal to or more than a threshold value, and a case where the variation degree is less than the threshold value.

The advice information generation unit 15 can generate and output, in a case where a variation degree is equal to or more than the threshold value, i.e., in a case where a variation among traveling distances or carrying amounts for times each is relatively large, advice information for suggesting, in a stage where a degree of deterioration of a predetermined electric vehicle is relatively small, a re-examination of a usage method for the electric vehicle.

Then, the advice information generation unit 15 can generate and output, in a case where a variation degree is less than the threshold value, i.e., in a case where a variation among traveling distances or carrying amounts for times each is relatively small, advice information for suggesting, in a stage where a degree of deterioration of a predetermined electric vehicle is relatively large, a re-examination of a usage method for the electric vehicle. Hereinafter, one example is described.

The advice information generation unit 15 may generate and output, in a case where, for example, a variation degree is equal to or more than the threshold value and an SOH (or electricity consumption) decreases to a first reference value or more from a time of introduction, advice information for suggesting a re-examination of a usage method for the electric vehicle.

Further, the advice information generation unit 15 may generate and output, in a case where, for example, a variation degree is less than the threshold value and an SOH (or electricity consumption) decreases to a second reference value or more from a time of introduction, advice information for suggesting a re-examination of a usage method for the electric vehicle. The second reference value is a value larger than the first reference value.

The advice information indicates that, due to deterioration of a battery, it is difficult to carry out current transportation and therefore inconvenience such that occurrence of running out of electricity during transportation is caused, it is difficult to perform transportation according to a time schedule since charge processing using a sufficient time is required, and the like may be caused.

Then, in the advice information, for such a reason, a re-examination of a transportation task, repurchase of an electric vehicle, or the like is suggested. For example, in a case where a decrease in an SOH (or electricity consumption) from a time of introduction is equal to or more than a third reference value, the advice information generation unit 15 may generate advice information suggesting repurchase. Then, in a case where a decrease in an SOH (or electricity consumption) from a time of introduction is less than the third reference value, the advice information generation unit 15 may generate advice information suggesting a re-examination of a transportation task. Note that, the third reference value is a value larger than both of the first reference value and the second reference value.

Note that, the advice information generation unit 15 may include, in addition to the function described above, a function of further generating a re-examination idea for a transportation task.

The advice information generation unit 15 extracts, in a case where, for example, a re-examination of a transportation task of a first electric vehicle is suggested, from among other electric vehicles, an electric vehicle with a state better than in the first electric vehicle (e.g., an electric vehicle with an SOH larger than in the first electric vehicle).

Then, the advice information generation unit 15 computes a requisite power required in a case where one or a plurality of transportation tasks carried out by the first electric vehicle so far are carried out by the extracted electric vehicle. Then, the advice information generation unit 15 decides, based on a requisite power for each of the transportation tasks, whether the first electric vehicle is replaceable with the extracted electric vehicle. These pieces of processing are achieved by processing similar to the requisite power computation unit 12 and the number of vehicles computation unit 13 described above.

Then, in a case where decision is performed as being replaceable, the advice information generation unit 15 generates advice information that transportation carried out by the first electric vehicle so far is carried out by the extracted electric vehicle from now on.

Further, the advice information generation unit 15 may decide, based on a similar method, whether the first electric vehicle can carry out transportation tasks carried out by another plurality of electric vehicles each. Then, in a case where there is a transportation task which can be carried out, the advice information generation unit 15 may generate advice information that transportation indicated by the transportation task is carried out by the first electric vehicle from now on.

Other configurations of the processing apparatus 10 are similar to those of the first to third example embodiments.

According to the processing apparatus 10 of the present example embodiment, an advantageous effect similar to that of the first to third example embodiments is achieved. Further, according to the processing apparatus 10 of the present example embodiment, after introduction of an electric vehicle, an operation using the electric vehicle can be assisted. Care after the introduction can be taken, and therefore an increase of transportation companies which decide to introduce an electric vehicle is expected.

### Modified Example

Herein, a modified example applicable to the first to fourth example embodiments is described. According to the first to fourth example embodiments, the processing apparatus 10 has decided, for each transportation vehicle, whether replacement with an electric vehicle is possible, based on a past transportation task.

As a modified example, a processing apparatus 10 may decide, for each transportation route, whether replacement with an electric vehicle is possible, based on past transportation tasks. In the case of the modified example, a transportation task acquisition unit 11 acquires transportation tasks of a plurality of transportation routes each. A requisite power computation unit 12 computes, for each of the transportation tasks, a requisite power being an amount of power required in a case where the transportation task is carried out by using a predetermined electric vehicle. Then, a number of vehicles computation unit 13 computes, based on the requisite power for each of the transportation tasks, the number of transportation routes where replacement with the predetermined electric vehicle is possible. Details of processing based on the transportation task acquisition unit 11, the requisite power computation unit 12, and the number of vehicles computation unit 13 are similar to those described according to the first to fourth example embodiments.

While with reference to the accompanying drawings, the example embodiments according to the present invention have been described, the example embodiments are exemplification of the present invention, and various configurations other than the above-described configurations are employable. The configurations according to the above-described example embodiments may be combined with each other, and a part of a configuration may be replaced with another configuration. Further, the configurations according to the above-described example embodiments may be added with various modifications to an extent without departing from the gist of the present invention. Further, configurations and processing disclosed according to the example embodiments and the modified example described above may be combined with each other.

Further, in a plurality of flowcharts used in the above-described description, a plurality of steps (pieces of processing) are described in order, but execution order of steps to be executed according to each example embodiment is not limited to the described order. According to each example embodiment, order of illustrated steps can be modified within an extent that there is no harm in context. Further, the above-described example embodiments can be combined within an extent that there is no conflict in content.

Note that, in the present specification, “acquisition” includes at least any one of: a matter that “a local apparatus fetches data stored in another apparatus or a storage medium (active acquisition)”, based on user input or based on an instruction from a program, e.g., a matter that reception is executed by making a request or an inquiry to another apparatus, a matter that reading is executed by accessing another apparatus or a storage medium, and the like; a matter that “data output from another apparatus are input to a local apparatus (passive acquisition)”, based on user input or based on an instruction from a program, e.g., a matter that data distributed (or transmitted, push-notified, and the like) are received, and a matter that selective acquisition is executed from among received pieces of data or information; and a matter that “new data are generated by data editing (conversion to text, data rearrangement, partial data extraction, file-format modification, and like) and the new data are acquired”.

The whole or part of the example embodiments described above can be described as, but not limited to, the following supplementary notes.
1. A processing apparatus including:
   a transportation task acquisition unit that acquires transportation tasks carried out by a plurality of transportation vehicles each;
   a requisite power computation unit that computes, for each of the transportation tasks, a requisite power being an amount of power required in a case where the transportation task is carried out by using a predetermined electric vehicle; and
   a number of vehicles computation unit that computes, based on the requisite power for each of the transportation tasks, the number of the transportation vehicles replaceable with the predetermined electric vehicle.
2. The processing apparatus according to supplementary note 1, wherein
   the transportation task indicates a transportation destination, transportation order, and a weight of a transportation target object, and
   the requisite power computation unit computes, based on the transportation task, the requisite power required in a case where the transportation task is carried out by using the predetermined electric vehicle.
3. The processing apparatus according to supplementary note 1 or 2, wherein
   the transportation task acquisition unit
      acquires a plurality of the transmission tasks carried out by each of the transportation vehicles,
   the requisite power computation unit
      computes the requisite power in each of a plurality of the transportation tasks carried out by each of the transportation vehicles, and
   the number of vehicles computation unit
      decides, based on the requisite power in each of a plurality of the transportation tasks carried out by each of the transportation vehicles, whether each of the transportation vehicles is replaceable with the predetermined electric vehicle.
4. The processing apparatus according to supplementary note 3, wherein
   the number of vehicles computation unit
      decides, in a case where a predetermined number or more or a predetermined ratio or more of a plurality of the transportation tasks carried out by each of the transportation vehicles satisfies a predetermined condition based on the requisite power, whether each of the transportation vehicles is replaceable with the predetermined electric vehicle.
5. The processing apparatus according to supplementary note 4, wherein
   the number of vehicles computation unit
      decides, based on a variation degree of the requisite powers in a plurality of the transportation tasks each carried out by each of the transportation vehicles, whether each of the transportation vehicles is replaceable with the predetermined electric vehicle.
6. The processing apparatus according to supplementary note 4 or 5, wherein
   the predetermined condition includes at least one of
      a matter that the requisite power is equal to or less than a first threshold value, and
      a matter that the requisite power is larger than the first threshold value and equal to or less than a second threshold value, and charge processing for a predetermined amount of power is possible while the transportation task is carried out.
7. The processing apparatus according to supplementary note 6, wherein
   the number of vehicles computation unit
      computes, based on a difference between the requisite power and the first threshold value, the predetermined amount of power.
8. The processing apparatus according to supplementary note 1 or 2, wherein
   the number of vehicles computation unit decides, as being replaceable with the predetermined electric vehicle, at least one of
      the transportation vehicle involved in the transportation task in which the requisite power is equal to or less than a first threshold value, and
      the transportation vehicle involved in the transportation task in which the requisite power is larger than the first threshold value and equal to or less than a second threshold value, and charge processing for a predetermined amount of power is possible while the transportation task is carried out.
9. The processing apparatus according to any one of supplementary notes 1 to 8, wherein
   the number of vehicles computation unit further computes at least one of a cost in a case where replacement of a computed number of vehicles is performed, and a CO₂ reduction effect.
10. The processing apparatus according to any one of supplementary notes 1 to 9, further including:
   a monitoring unit that monitors a change in a state of the predetermined electric vehicle replaced from the transportation vehicle; and
   an advice information generation unit that generates and outputs, based on the state at a current time and the transportation tasks carried out by the predetermined electric vehicle so far, advice information relating to a future usage method of the predetermined electric vehicle.
11. A processing method including,
   by one or more computers;
      acquiring transportation tasks carried out by a plurality of transportation vehicles each;
      computing, for each of the transportation tasks, a requisite power being an amount of power required in a case where the transportation task is carried out by using a predetermined electric vehicle; and
      computing, based on the requisite power for each of the transportation tasks, the number of the transportation vehicles replaceable with the predetermined electric vehicle.
12. A medium recording a program causing a computer to function as:
   a transportation task acquisition unit that acquires transportation tasks carried out by a plurality of transportation vehicles each;
   a requisite power computation unit that computes, for each of the transportation tasks, a requisite power being an amount of power required in a case where the transportation task is carried out by using a predetermined electric vehicle; and
   a number of vehicles computation unit that computes, based on the requisite power for each of the transportation tasks, the number of the transportation vehicles replaceable with the predetermined electric vehicle.
13. A program causing a computer to function as:
   a transportation task acquisition unit that acquires transportation tasks carried out by a plurality of transportation vehicles each;
   a requisite power computation unit that computes, for each of the transportation tasks, a requisite power being an amount of power required in a case where the transportation task is carried out by using a predetermined electric vehicle; and
   a number of vehicles computation unit that computes, based on the requisite power for each of the transportation tasks, the number of the transportation vehicles replaceable with the predetermined electric vehicle.

### REFERENCE SIGNS LIST

10 Processing apparatus
11 Transportation task acquisition unit
12 Requisite power computation unit
13 Number of vehicles computation unit
14 Monitoring unit
15 Advice information generation unit
1A Processor
2A Memory
3A Input/output I/F
4A Peripheral circuit
5A Bus

What is claimed is:

1. A processing apparatus comprising:
at least one memory configured to store one or more instructions; and
at least one processor configured to execute the one or more instructions to:
acquire transportation tasks carried out by a plurality of transportation vehicles each;
compute, for each of the transportation tasks, a requisite power being an amount of power required in a case where the transportation task is carried out by using a predetermined electric vehicle; and
compute, based on the requisite power for each of the transportation tasks, a number of the transportation vehicles replaceable with the predetermined electric vehicle.

2. The processing apparatus according to claim 1, wherein
the transportation task indicates a transportation destination, transportation order, and a weight of a transportation target object, and
the at least one processor is further configured to execute the one or more instructions to compute, based on the transportation task, the requisite power required in a case where the transportation task is carried out by using the predetermined electric vehicle.

3. The processing apparatus according to claim 1, wherein the at least one processor is further configured to execute the one or more instructions to
acquire a plurality of the transmission tasks carried out by each of the transportation vehicles,
compute the requisite power in each of a plurality of the transportation tasks carried out by each of the transportation vehicles, and
decide, based on the requisite power in each of a plurality of the transportation tasks carried out by each of the transportation vehicles, whether each of the transportation vehicles is replaceable with the predetermined electric vehicle.

4. The processing apparatus according to claim 3, wherein
the at least one processor is further configured to execute the one or more instructions to
decide, in a case where a predetermined number or more or a predetermined ratio or more of a plurality of the transportation tasks carried out by each of the transportation vehicles satisfies a predetermined condition based on the requisite power, whether each of the transportation vehicles is replaceable with the predetermined electric vehicle.

5. The processing apparatus according to claim 4, wherein
the at least one processor is further configured to execute the one or more instructions to
decide, based on a variation degree of the requisite powers in a plurality of the transportation tasks each carried out by each of the transportation vehicles, whether each of the transportation vehicles is replaceable with the predetermined electric vehicle.

6. The processing apparatus according to claim 4, wherein
the predetermined condition includes at least one of
a matter that the requisite power is equal to or less than a first threshold value, and
a matter that the requisite power is larger than the first threshold value and equal to or less than a second threshold value, and charge processing for a predetermined amount of power is possible while the transportation task is carried out.

7. The processing apparatus according to claim 6, wherein
the at least one processor is further configured to execute the one or more instructions to
compute, based on a difference between the requisite power and the first threshold value, the predetermined amount of power.

8. The processing apparatus according to claim 1, wherein
the at least one processor is further configured to execute the one or more instructions to decide, as being replaceable with the predetermined electric vehicle, at least one of
the transportation vehicle involved in the transportation task in which the requisite power is equal to or less than a first threshold value, and
the transportation vehicle involved in the transportation task in which the requisite power is larger than the first threshold value and equal to or less than a second threshold value, and charge processing for a predetermined amount of power is possible while the transportation task is carried out.

9. The processing apparatus according to claim 1, wherein
the at least one processor is further configured to execute the one or more instructions to compute at least one of a cost in a case where replacement of a computed number of vehicles is performed, and a CO₂ reduction effect.

10. The processing apparatus according to claim 1, wherein the at least one processor is further configured to execute the one or more instructions to:
monitor a change in a state of the predetermined electric vehicle replaced from the transportation vehicle; and
generate and output, based on the state at a current time and the transportation tasks carried out by the predetermined electric vehicle so far, advice information relating to a future usage method of the predetermined electric vehicle.

11. A processing method comprising,
by one or more computers;
acquiring transportation tasks carried out by a plurality of transportation vehicles each;
computing, for each of the transportation tasks, a requisite power being an amount of power required in a case where the transportation task is carried out by using a predetermined electric vehicle; and
computing, based on the requisite power for each of the transportation tasks, a number of the transportation vehicles replaceable with the predetermined electric vehicle.

12. A non-transitory storage medium recording a program causing a computer to:
acquire transportation tasks carried out by a plurality of transportation vehicles each;
compute, for each of the transportation tasks, a requisite power being an amount of power required in a case where the transportation task is carried out by using a predetermined electric vehicle; and
compute, based on the requisite power for each of the transportation tasks, a number of the transportation vehicles replaceable with the predetermined electric vehicle.

13. The processing method according to claim 11, wherein
the transportation task indicates a transportation destination, transportation order, and a weight of a transportation target object, and
the one or more computers compute, based on the transportation task, the requisite power required in a case where the transportation task is carried out by using the predetermined electric vehicle.

14. The processing method according to claim 11, wherein
the one or more computers
acquire a plurality of the transmission tasks carried out by each of the transportation vehicles,
compute the requisite power in each of a plurality of the transportation tasks carried out by each of the transportation vehicles, and
decide, based on the requisite power in each of a plurality of the transportation tasks carried out by each of the transportation vehicles, whether each of the transportation vehicles is replaceable with the predetermined electric vehicle.

15. The processing method according to claim 14, wherein
the one or more computers
decide, in a case where a predetermined number or more or a predetermined ratio or more of a plurality of the transportation tasks carried out by each of the transportation vehicles satisfies a predetermined condition based on the requisite power, whether each of the transportation vehicles is replaceable with the predetermined electric vehicle.

16. The processing method according to claim 15, wherein
the one or more computers
decide, based on a variation degree of the requisite powers in a plurality of the transportation tasks each carried out by each of the transportation vehicles, whether each of the transportation vehicles is replaceable with the predetermined electric vehicle.

17. The non-transitory storage medium according to claim 12, wherein
the transportation task indicates a transportation destination, transportation order, and a weight of a transportation target object, and
the program causing the computer to compute, based on the transportation task, the requisite power required in a case where the transportation task is carried out by using the predetermined electric vehicle.

18. The non-transitory storage medium according to claim 12, wherein
the program causing the computer to
acquire a plurality of the transmission tasks carried out by each of the transportation vehicles,
compute the requisite power in each of a plurality of the transportation tasks carried out by each of the transportation vehicles, and
decide, based on the requisite power in each of a plurality of the transportation tasks carried out by each of the transportation vehicles, whether each of the transportation vehicles is replaceable with the predetermined electric vehicle.

19. The non-transitory storage medium according to claim 18, wherein
the program causing the computer to
decide, in a case where a predetermined number or more or a predetermined ratio or more of a plurality of the transportation tasks carried out by each of the transportation vehicles satisfies a predetermined condition based on the requisite power, whether each of the transportation vehicles is replaceable with the predetermined electric vehicle.

20. The non-transitory storage medium according to claim 19, wherein
the program causing the computer to
decide, based on a variation degree of the requisite powers in a plurality of the transportation tasks each carried out by each of the transportation vehicles, whether each of the transportation vehicles is replaceable with the predetermined electric vehicle.
